(19) United States
(12) Patent Application Publication
(10) Pub. No.: US 2026/0112693 A1
(43) Pub. Date: Apr. 23, 2026

(54) SOLID ELECTROLYTE DOPED WITH NITROGEN AND ALL SOLID-STATE BATTERY COMPRISING SAME

(71) Applicant: Factorial Inc., Billerica, MA (US)

(72) Inventors: Yuying Steven Lin, Billerica, MA (US); Fang Hao, Andover, MA (US); Hyun Seok Kim, Lexington, MA (US); Daniel Wakaba, Lawrence, MA (US)

(21) Appl. No.: 19/469,453

(22) PCT Filed: Jun. 16, 2025
(86) PCT No.: PCT/US2025/033714

§ 371 Date: Sep. 26, 2025

Related U.S. Application Data
(60) Provisional application No. 63/663,986, filed on Jun. 25, 2024.

(51) Int. Cl. H01M 10/0562; H01M 4/62

(52) U.S. Cl. CPC H01M 10/0562; H01M 4/622; H01M 4/625; H01M 2300/008

(57) ABSTRACT

Disclosed is a solid argyrodite electrolyte doped with nitrogen (N). In some embodiments, the solid argyrodite electrolyte has a formula (I), Li₇₋ₙ₊ₓPS₆₋ₙ₋ₓNₓHaₙ (I), wherein Ha is a halogen element, 0.01≤x≤0.1, and 1.0<n<2.0. In some embodiments, 1.2≤n≤1.8. In some embodiments, 1.2≤n≤1.6. In some embodiments, the ASSB comprising the solid electrolyte exhibits an increased CCD and an improved electrochemical performance.

### CROSS-REFERENCE

The present application claims the benefit of U.S. Ser. No. 63/663,986, filed Jun. 25, 2024, the entire content of which is incorporated herein by reference into this application.

### FIELD

Disclosed are a solid electrolyte doped with nitrogen and an all-solid-state battery (ASSB) comprising the same.

### BACKGROUND

Organic solvents in liquid electrolyte or semi-solid electrolyte are usually flammable and may cause fire or even explosion. Inorganic solid electrolytes for all-solid-state batteries (ASSBs) attract more attention due to their better safety profile in comparison to conventional solvents. Formation and growth of lithium dendrite, however, may penetrate the inorganic solid electrolyte and deteriorate the high-rate property, cycling performance and/or safety. Critical current density (CCD) is the maximum available current density of a solid-state battery without causing failure due to growth of lithium dendrite. CCD is related to the power density and is crucially important in evaluating efficacy of solid electrolytes. However, solid electrolytes usually exhibit a lower CCD in comparison with liquid electrolytes. Thus, there remains a need for new ASSBs with higher CCD and methods for preparing the same.

### SUMMARY

The present disclosure provides a solid argyrodite electrolyte doped with nitrogen (N) and an all-solid-state battery (ASSB) comprising a solid electrolyte (SE) layer comprising the same. In some embodiments, the solid argyrodite electrolyte has a formula (I), Li₇₋ₙ₊ₓPS₆₋ₙ₋ₓNₓHaₙ (I), wherein Ha is a halogen element, 0.01≤x≤0.1, and 1.0<n<2.0. In some embodiments, Ha comprises at least one selected from the group consisting of fluorine (F), chlorine (Cl), bromine (Br), iodine (I), astatine (At), and tennessine (Ts).

In some embodiments, the ASSB comprising the solid electrolyte exhibits an increased CCD and an improved electrochemical performance.

The following terms shall be used to describe the present disclosure. In the absence of a specific definition set forth herein, the terms used to describe the present disclosure shall be given their common meaning as understood by those of ordinary skill in the art.

A solid electrolyte (SE) layer (alternatively, solid electrolyte membrane or electrolyte film) refers to a thin structure that allows transportation or flow of ions and prevents electronic contact between a cathode and an anode. An SE layer may or may not comprise a scaffold layer which depends on the preparation method. An SE layer has a typical thickness in a range from 5 μm to 300 μm.

A scaffold layer refers to a mechanical support layer that is impregnated with an electrolyte. An example of a scaffold layer includes a non-woven substrate with self-supporting property. In some embodiments, scaffold layer is alternatively referred as mechanical support layer, mechanical scaffold layer, or support layer.

An anode layer comprises an anode current collector and an optional anode active material layer. An anode protective layer is a layer or sublayer disposed between the SE layer and an anode layer. Without wishing to be bound by any theory, an anode protective layer may protect the anode layer, SE layer or both.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 illustrates a representative configuration of an all-solid state battery (ASSB) with an SE layer.

FIG. 2 shows the ionic conductivities of representative solid argyrodite electrolytes according to some embodiments of the present disclosure.

FIG. 3 shows the CCDs of representative solid argyrodite electrolytes according to some embodiments of the present disclosure.

FIG. 4 shows the XRD patterns of representative argyrodite solid electrolytes according to some embodiments of the present disclosure.

FIG. 5 shows rate performance of a pouch cell comprising a representative solid argyrodite electrolyte according to some embodiments of the present disclosure.

FIG. 6 shows rate performance of a pouch cell comprising a representative solid argyrodite electrolyte according to some embodiments of the present disclosure.

FIG. 7 shows cycling performance of a pouch cell comprising a representative solid argyrodite electrolyte according to some embodiments of the present disclosure.

FIG. 8 shows cycling performance of a pouch cell comprising a representative solid argyrodite electrolyte according to some embodiments of the present disclosure.

### DETAILED DESCRIPTION

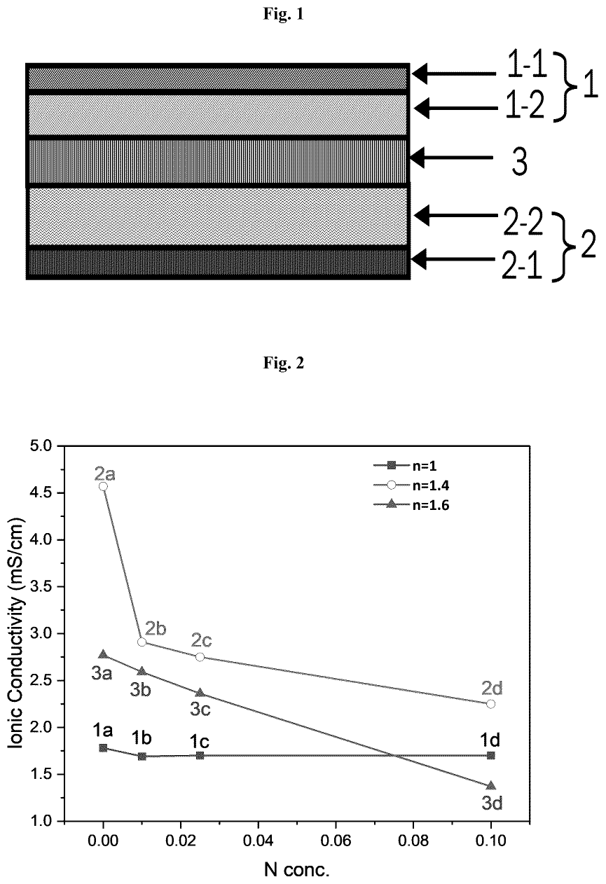

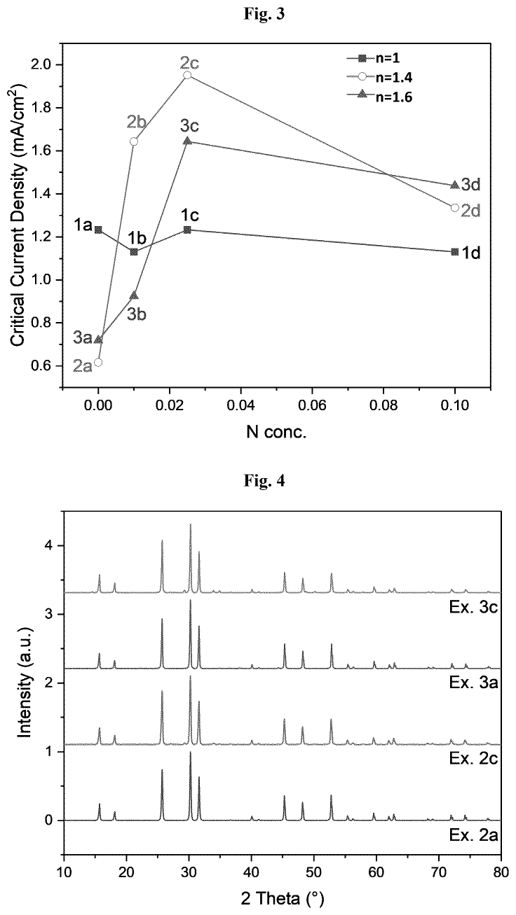

A cross-sectional view of an all-solid state battery (ASSB) is shown in FIG. 1. Such ASSB comprises an anode layer (1), a cathode layer (2), and a solid electrolyte (SE) layer (3) interposed between the anode layer (1) and the cathode layer (2). In some embodiments, the anode layer (1) comprises an anode current collector (1-1) and an anode active material layer (1-2). In some embodiments, the cathode layer (2) comprises a cathode current collector (2-1) and a cathode active material layer (2-2).

The present disclosure provides a solid argyrodite electrolyte (alternatively, argyrodite solid electrolyte). Also disclosed is a solid electrolyte (SE) layer comprising the solid argyrodite electrolyte and an all-solid-state battery (ASSB) comprising the SE layer. In some embodiments, the solid argyrodite electrolyte has a formula (I), Li₇₋ₙ₊ₓPS₆₋ₙ₋ₓNₓHaₙ (I), wherein Ha is a halogen element, 0.01≤x≤0.1, and 1.0<n<2.0. In some embodiments, Ha comprises at least one selected from the group consisting of fluorine (F), chlorine (Cl), bromine (Br), iodine (I), astatine (At), and tennessine (Ts).

In some embodiments, the total molar amounts of halogen elements (n) are higher than 1.0. In some embodiments, the total molar amounts of halogens (n) are equal to or greater than 1.10, 1.20 or 1.30, i.e., n≥1.10, n≥1.20, or n≥1.30. In some embodiments, the total molar amount of halogen elements in formula (I) is no greater than 2.0. In some embodiments, the total molar amount of halogen elements in formula (I) is in a range from 1.2 to 1.6. In some embodiments, the total molar amount of halogens (n) is in a range from 1.05 to 1.80, from 1.05 to 1.75, from 1.05 to 1.70, from 1.05 to 1.65, from 1.05 to 1.60, from 1.05 to 1.55, from 1.05 to 1.50, from 1.05 to 1.45, from 1.05 to 1.40, from 1.10 to 1.80, from 1.10 to 1.75, from 1.10 to 1.70, from 1.10 to 1.65, from 1.10 to 1.60, from 1.10 to 1.55, from 1.10 to 1.50, from 1.10 to 1.45, from 1.10 to 1.40, from 1.15 to 1.80, from 1.15 to 1.75, from 1.15 to 1.70, from 1.15 to 1.65, from 1.15 to 1.60, from 1.15 to 1.55, from 1.15 to 1.50, from 1.15 to 1.45, from 1.15 to 1.40, from 1.20 to 1.80, from 1.20 to 1.75, from 1.20 to 1.70, from 1.20 to 1.65, from 1.20 to 1.60, from 1.20 to 1.55, from 1.20 to 1.50, from 1.20 to 1.45, or from 1.20 to 1.40.

In some embodiments, the molar amount of N (x) is not greater than 0.1. In some embodiments, the total molar amount of N in formula (I) is equal to or greater than 0.01. In some embodiments, the total molar amount of N in formula (I) is in a range from 0.01 to 0.1. In some embodiments, the molar amount of N (x) is in a range from 0.01 to 0.1, from 0.01 to 0.09, from 0.01 to 0.08, from 0.01 to 0.07, from 0.01 to 0.06, from 0.01 to 0.05, from 0.01 to 0.04, from 0.02 to 0.1, from 0.02 to 0.09, from 0.02 to 0.08, from 0.02 to 0.07, from 0.02 to 0.06, from 0.02 to 0.05, or from 0.02 to 0.04.

In some embodiments, the total molar amount of lithium (7−n+x) in Formula (I) has a value higher than 5.0 and lower than 6.0. When n is in a range from 1.2 to 1.8 and x is in a range from 0.01 to 0.1, the total molar amount of lithium (7−n+x) is in a range from 5.21 to 5.90. When n is in a range from 1.2 to 1.6, the total molar amount of lithium (7−n+x) is in a range from around 5.41 to 5.90. When n is in a range from 1.2 to 1.4, the total molar amount of lithium (7−n+x) is in a range from around 5.61 to 5.90. In some embodiments, the total molar amount of lithium in formula (I) is around 5.41, 5.43, 5.50, 5.60, 5.61, 5.63, 5.7 or 5.8.

In some embodiments, the solid argyrodite electrolyte comprises at least one selected from the group consisting of Li_{5.61}PS_{4.59}N_{0.01}Cl_{1.4}, Li_{5.625}PS_{4.575}N_{0.025}Cl_{1.4}, Li_{5.7}PS_{4.5}N_{0.1}Cl_{1.4}, Li_{5.61}PS_{4.59}N_{0.01}F_{1.4}, Li_{5.625}PS_{4.575}N_{0.025}F_{1.4}, Li_{5.7}PS_{4.5}N_{0.1}F_{1.4}, Li_{5.61}PS_{4.59}N_{0.01}Br_{1.4}, Li_{5.625}PS_{4.575}N_{0.025}Br_{1.4}, Li_{5.7}PS_{4.5}N_{0.1}Br_{1.4}, Li_{5.61}PS_{4.59}N_{0.01}I_{1.4}, Li_{5.625}PS_{4.575}N_{0.025}I_{1.4}, Li_{5.7}PS_{4.5}N_{0.1}I_{1.4}, Li_{5.41}PS_{4.39}N_{0.01}Cl_{1.6}, Li_{5.425}PS_{4.375}N_{0.025}Cl_{1.6}, Li_{5.5}PS_{4.3}N_{0.1}Cl_{1.6}, Li_{5.41}PS_{4.39}N_{0.01}F_{1.6}, Li_{5.425}PS_{4.375}N_{0.025}F_{1.6}, Li_{5.5}PS_{4.3}N_{0.1}F_{1.6}, Li_{5.41}PS_{4.39}N_{0.01}Br_{1.6}, Li_{5.425}PS_{4.375}N_{0.025}Br_{1.6}, Li_{5.5}PS_{4.3}N_{0.1}Br_{1.6}, Li_{5.41}PS_{4.39}N_{0.01}I_{1.6}, Li_{5.425}PS_{4.375}N_{0.025}I_{1.6}, Li_{5.5}PS_{4.3}N_{0.1}I_{1.6}, and mixtures thereof.

In some embodiments, the present disclosure provides an ASSB comprising a cathode layer, an anode layer, and a solid electrolyte (SE) layer between the cathode layer and the anode layer, wherein the SE layer comprises an argyrodite solid electrolyte as disclosed herein.

In some embodiments, the ASSB exhibits a good ionic conductivity. In some embodiments, the solid argyrodite electrolyte exhibits an ionic conductivity of at least 1.25 mS/cm, at least 1.50 mS/cm, at least 1.75 mS/cm, at least 2.00 mS/cm, at least 2.25 mS/cm, or at least 2.50 mS/cm at 20° C.

In some embodiments, an ASSB comprising the argyrodite solid electrolyte as disclosed herein exhibits a desirable critical current density (CCD). In some embodiments, an ASSB comprising the solid argyrodite electrolyte exhibits a CCD of at least 0.75 mA/cm², at least 1.00 mA/cm², at least 1.25 mA/cm², at least 1.50 mA/cm² or at least 1.75 mA/cm² at 75° C.

In some embodiments, the sulfide electrolyte as disclosed herein has a cubic crystal structure. In some embodiments, the sulfide electrolyte has a crystal structure in the F4̅3m space group as verified by XRD. In some embodiments, the solid electrolyte is a sulfide solid electrolyte having an argyrodite crystal structure. In some embodiments, the sulfide solid electrolyte has an argyrodite crystal structure with three peaks at 2θ=25.8±0.3, 30.3±0.4 and 31.7±0.4 in X-ray diffractometry using a CuKα ray.

In some embodiments, the SE layer comprising the nitrogen doped argyrodite electrolyte has an thickness in a range from 5 μm to 300 μm, from 10 μm to 300 μm, from 20 μm to 300 μm, from 50 μm to 300 μm, from 5 μm to 200 μm, from 10 μm to 200 μm, from 20 μm to 200 μm, from 50 μm to 200 μm, from 5 μm to 100 μm, from 10 μm to 100 μm, from 20 μm to 100 μm, from 50 μm to 100 μm, from 5 μm to 50 μm, from 10 μm to 50 μm, from 20 μm to 50 μm, or any and all ranges and subranges therebetween.

In some embodiments, the SE layer has a lithium-ion conductivity of no less than 0.05 mS/cm, no less than 0.1 mS/cm, no less than 0.2 mS/cm, no less than 0.5 mS/cm, no less than 0.75 mS/cm, no less than 1.0 mS/cm, no less than 2.0 mS/cm, or no less than 5.0 mS/cm, no less than 7.5 mS/cm or no less than 10.0 mS/cm. In some embodiments, the SE layer has a lithium-ion conductivity at 20° C. in a range from 0.05 mS/cm to 10.0 mS/cm, from 0.1 mS/cm to 10.0 mS/cm, from 0.25 mS/cm to 10.0 mS/cm, from 0.5 mS/cm to 10.0 mS/cm, from 0.75 mS/cm to 10.0 mS/cm, from 1.0 mS/cm to 10.0 mS/cm, from 2.0 mS/cm to 10.0 mS/cm, from 0.05 mS/cm to 7.5 mS/cm, from 0.1 mS/cm to 7.5 mS/cm, from 0.25 mS/cm to 7.5 mS/cm, from 0.5 mS/cm to 7.5 mS/cm, from 0.75 mS/cm to 7.5 mS/cm, from 1.0 mS/cm to 7.5 mS/cm, from 2.0 mS/cm to 7.5 mS/cm, from 0.05 mS/cm to 5.0 mS/cm, from 0.1 mS/cm to 5.0 mS/cm, from 0.25 mS/cm to 5.0 mS/cm, from 0.5 mS/cm to 5.0 mS/cm, from 0.75 mS/cm to 5.0 mS/cm, from 1.0 mS/cm to 5.0 mS/cm, or any and all ranges and subranges therebetween.

In some embodiments, the ASSB exhibits a capacity retention rate of at least 97.5%, at least 98.0%, at least 98.5%, at least 99.0%, at least 99.5% or at least 99.75% after at least 50 cycles at a rate of C/3 at 45° C.

In some embodiments, the ASSB exhibits a capacity retention rate of at least 94.0% at least 94.5%, at least 95.0%, at least 95.5%, at least 96.0%, at least 96.5%, at least 97.0%, at least 97.5%, at least 98.0%, at least 98.5%, or at least 99.0%, after at least 100 cycles at a rate of C/3 at 45° C.

In some embodiments, the cycling test can be performed at other C rates such as C/6, C/4, C/2, C, 1C, 2C, 3C, 5C, or any intermediate rate therebetween. In some embodiments, the cycling test can be performed at other temperatures such as −20° C., −10° C., 0° C., 10° C., 20° C., 25° C., 30° C., 40° C., 50° C., 80° C., or any intermediate temperature therebetween. In some embodiments, the number of cycles to reach 90% for a battery with nitrogen doped SE is at least 10%, at least 15%, at least 20%, at least 25%, at least 30%, at least 40%, at least 50%, or at least 60% longer than that of an identical one with an SE not doped with nitrogen.

In one embodiment, the cathode active material layer in the cathode layer comprises a cathode active material (CAM). In one embodiment, the CAM contains Li, Ni, and Co. In one embodiment, the CAM contains Li, Ni, and Co and at least one of Mn and Al. In one embodiment, the CAM contains at least one of Fe, and P.

In one embodiment, the CAM experiences a redox reaction at a potential of 2 V or above over Li/Li+ during operation of an all solid-state battery (ASSB).

In some embodiments, an ASSB comprises an anode layer, a cathode layer and an SE layer therebetween. In some embodiments, an anode layer comprises an anode current collector and optionally an anode active material layer. In some embodiments, the anode active material layer comprises an anode active material such as lithium metal or a lithium alloy. In some embodiments, the anode active material comprises at least one selected from the group consisting of lithium, sodium, magnesium, aluminum, silicon, calcium, titanium, manganese, iron, cobalt, nickel, zinc, molybdenum, silver, indium, tin, and tungsten.

In some embodiments, the anode layer comprises an anode current collector without an anode active material layer. In some embodiments, an anode active material layer is assembled into an ASSB prior to the first charge. In some embodiments, an anode active material layer is formed after the first charge.

In some embodiments, the anode active material layer of the anode layer contains an anode active material. In some embodiments, the anode active material layer may further include a carbon-based conductive material. In some embodiments, the carbon-based conductive material comprises at least one selected from the group consisting of carbon black, acetylene black, Ketjen black, channel black, furnace black, lamp black, thermal black, natural graphite and artificial graphite.

In some embodiments, an ASSB comprises a cathode layer, a solid electrolyte (SE) layer, an anode protective layer, and an anode layer in the order. In some embodiments, the anode protective layer is a layer comprising a carbonaceous material and a binder in the absence of lithium-alloyable element (alternatively lithiophilic element).

In some embodiments, the anode protective layer is a composite layer. In some embodiments, the composite layer comprises a carbonaceous material, a binder, and particles of an element M1 alloyable with lithium, wherein the particles of element M1 are distributed in a matrix of the carbonaceous material. In some embodiments, the carbonaceous material in the anode protective layer comprises at least one selected from the group consisting of carbon black, acetylene black, Ketjen black, channel black, furnace black, lamp black, thermal black, natural graphite and artificial graphite. In some embodiments, the element M1 is at least one selected from the group consisting of Ag, Zn, Ti, Cd, Mg, Al, Ga, Si, Ge, In, Sn, Pb, Bi, and Sb. In some embodiments, the anode protective layer has a thickness in a range from 0.1 μm to 50 μm. In some embodiments, the carbonaceous material has a volume percentage in a range from 50% to 90%. In some embodiments, the particles of element M1 have a volume percentage in a range from 10% to 50%. In some embodiments, the particles of element M1 are nanoparticles with an average particle size (D50) in a range from 20 nm to 80 nm in the composite or the composite layer. In some embodiments, the composite further comprises particles of a second element M2 that is not alloyable with lithium. In some embodiments, the second element M2 is at least one selected from the group consisting of Cu, Mo, Ir, W, Co, Ni, Ru, Fe, Se, Ta, Nb, V, and Zr.

In some embodiments, the polymer binder has a weight percentage in a range from 3.0 wt % to 10 wt % in the anode protective layer. In some embodiments, the polymer binder in the anode protective layer comprises a non-aqueous acrylate-type binder, a rubber-type binder such as styrene-butadiene rubber (SBR), poly(vinylidene fluoride) (PVDF), polyethylene (PE), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, polyarylate, cellulose acetate, cellulose acetate butyrate, cellulose acetate propionate, polysaccharide polymer and carboxyl methyl cellulose.

In some embodiments, a cathode layer of an ASSB comprises a cathode active material layer and a cathode current collector. In one embodiment, the cathode active material layer of an ASSB comprises a cathode active material. In some embodiments, the ASSB has a relatively high cathode loading. In some embodiments, the ASSB has a cathode loading of at least 4.0 mAh/cm², at least 4.5 mAh/cm², at least 5.0 mAh/cm², at least 5.5 mAh/cm², at least 6.0 mAh/cm², at least 6.5 mAh/cm², at least 6.8 mAh/cm², at least 7.2 mAh/cm², or at least 7.5 mAh/cm². A high cathode loading is critical to achieve a high energy density. However, a battery with a high cathode loading may be subject to a relatively fast decay, which ultimately leads to a lower capacity retention. In some embodiments, the present disclosure provides an ASSB having both a high cathode loading and a good cycling performance.

In some embodiments, the ASSB with the SE layer exhibits an initial specific capacity of at least 160 mAh/g, at least 165 mAh/g, at least 170 mAh/g, at least 175 mAh/g, at least 180 mAh/g, at least 185 mAh/g, or at least 190 mAh/g at a rate of C/3 at a temperature of 45° C. In some embodiments, the ASSB is tested at a pressure in a range from 0.5 MPa to 5.0 MPa.

In some embodiments, the ASSB comprising the SE layer exhibits an initial CE of at least 85.0%, at least 86.0%, at least 87.0%, at least 88.0%, at least 89.0% or at least 90.0% at a rate of C/3 at a temperature of 45° C.

In some embodiments, the SE layer exhibits an ionic conductivity of at least 1.3 mS/cm, at least 1.4 mS/cm, at least 1.5 mS/cm, at least 1.6 mS/cm, at least 1.7 mS/cm, or at least 1.8 mS/cm at 20° C.

In some embodiments, the ASSB with the SE layer exhibits a CCD of at least 1.20 mA/cm², at least 1.25 mA/cm², at least 1.30 mA/cm², at least 1.40 mA/cm², at least 1.50 mA/cm², at least 1.60 mA/cm², at least 1.70 mA/cm², or at least 1.80 mA/cm² at 75° C.

In some embodiments, the SE layer exhibits an ionic conductivity of at least 1.6 mS/cm, at least 1.7 mS/cm, or at least 1.8 mS/cm at 20° C., while the ASSB comprising the solid electrolyte layer exhibits a CCD of at least 1.20 mA/cm², at least 1.25 mA/cm², at least 1.30 mA/cm², at least 1.40 mA/cm², at least 1.50 mA/cm², at least 1.60 mA/cm², at least 1.70 mA/cm², or at least 1.80 mA/cm² at 75° C.

In some embodiments, the ASSB comprising the SE layer exhibits a cycling life of at least 5%, at least 10%, at least 15%, at least 20%, at least 25%, at least 30%, at least 35%, at least 40%, at least 45%, or at least 50% greater than that of one comprising an SE layer not doped with nitrogen.

In one aspect, the present disclosure provides a method of preparing an SE layer. In some embodiments, an SE layer may be prepared by a conventional slurry method, a semi-solid slurry method, or a solvent-free (alternatively solvent-less) method.

In some embodiment, an SE layer may be prepared by:
1) coating a slurry to a scaffold on a non-stick base, leading to a coated slurry on the non-stick base, wherein the slurry comprises a solid argyrodite electrolyte has a formula (I), Li₇₋ₙ₊ₓPS₆₋ₙ₋ₓNₓHaₙ (I), wherein Ha is a halogen element, 0.01≤x≤0.1, and 1.0<n<2.0, wherein Ha comprises at least one selected from the group consisting of fluorine (F), chlorine (Cl), bromine (Br), iodine (I), astatine (At), and tennessine (Ts),
2) drying the coated slurry on the non-stick base, leading to a solid electrolyte (SE) layer comprising the solid argyrodite electrolyte and the scaffold on the non-stick base; and
3) peeling the SE layer from the non-stick base, thereby obtaining the SE layer ready for subsequent assembly or lamination.

In one aspect, the present disclosure provides a method of preparing an ASSB. The method may comprise:
1) having an SE layer prepared as above, and
2) laminating an anode layer, the SE layer, and a cathode layer in the order, thus obtaining an ASSB comprising the anode layer, the SE layer and the cathode layer.

In some embodiments, the anode layer, the SE layer and the cathode layer are laminated or assembled under a warm isostatic pressing (WIP) process. In some embodiments, the WIP is conducted under a pressure in a range from 100 MPa to 500 MPa. In some embodiments, the WIP is performed at a temperature in a range from 20° C. to 100° C.

In some embodiments, the slurry comprises a polymeric binder. In some embodiments, the slurry comprises a solvent. In some embodiments, particles of an argyrodite solid electrolyte, a binder and a solvent are mixed in a planetary centrifugal mixer to prepare the slurry.

In some embodiments, the solvent has a weight percentage in a range from 25% to 75%, from 25% to 70%, from 25% to 65%, from 25% to 60%, from 25% to 55%, from 25% to 50%, from 25% to 45%, from 25% to 40%, from 30% to 75%, from 30% to 70%, from 30% to 65%, from 30% to 60%, from 30% to 55%, from 30% to 50%, from 30% to 45%, from 30% to 40%, from 35% to 75%, from 35% to 70%, from 35% to 65%, from 35% to 60%, from 35% to 55%, from 35% to 50%, from 35% to 45%, or all and any ranges and subranges therebetween in the slurry.

In some embodiments, the solvent comprises at least one selected from the group consisting of comprises xylene, isobutyl isobutyrate and mixtures thereof.

In some embodiments, the binder can be a solution-type or emulsion-type binder. In some embodiments, the binder is independently selected from the group consisting of a non-aqueous acrylate-type binder, a rubber-type binder such as styrene-butadiene rubber (SBR), poly(vinylidene fluoride) (PVDF), polyethylene (PE), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, polyarylate, cellulose acetate, cellulose acetate butyrate, cellulose acetate propionate, polysaccharide polymer and carboxyl methyl cellulose. In some embodiments, the binder is nonfibrillizable binder.

In some embodiments, an SE layer comprising the argyrodite electrolyte may be prepared by a solvent-less method. In some embodiments, the method comprises
combining particles of an inorganic electrolyte, and a fibrillizable binder at an elevated temperature in the absence of a solvent into a dough-like mixture; and
calendaring the dough-like mixture into an SE layer with a predetermined thickness.

In another aspect, the present disclosure provides a method of preparing an ASSB. The method may comprise:
1) laminating an anode layer, an anode protective layer, an SE layer, and a cathode layer in the order, thus obtaining an ASSB comprising the anode layer, the anode protective layer, the SE layer and the cathode layer.

In some embodiments, the anode protective layer comprises a carbonaceous material and a polymeric binder in the absence of lithium-alloyable elements. In some embodiments, the anode protective layer consists of a carbonaceous material and a polymeric binder

In some embodiments, the anode protective layer comprises a carbonaceous material, a polymeric binder and a lithium-alloyable element.

In some embodiments, the anode protective layer comprises a carbonaceous material, a polymeric binder, a lithium-alloyable element and an element that is not alloyable with lithium.

In some embodiments, the polymeric binder has a weight percentage in a range from 3.0 wt % to 10.0 wt % in the anode protective layer.

In some embodiments, the binder comprises at least one selected from the group consisting of styrene-butadiene rubber (SBR), poly(vinylidene fluoride) (PVDF), polyethylene (PE), vinylidene fluoride/hexafluoropropylene copolymer, polyvinylidene fluoride-co-trichloroethylene, polyacrylonitrile, polymethylmethacrylate, polyvinylpyrrolidone, polyvinylacetate, polyethylene-co-vinyl acetate, polyethylene oxide, polyarylate, cellulose acetate, cellulose acetate butyrate, cellulose acetate propionate, polysaccharide polymer, carboxyl methyl cellulose, and mixtures thereof.

In some embodiments, the lithium-alloyable element M1 is in the form of particles. In some embodiments, the lithium-alloyable element has a weight percentage in a range from 1% to 30%, from 2.5% to 30%, from 5% to 30%, from 7.5% to 30%, from 1% to 25%, from 2% to 25%, from 3% to 25%, from 4% to 25%, from 5% to 25%, from 7.5% to 25%, from 1% to 20%, from 2% to 20%, from 3% to 20%, from 5% to 20%, from 7.5% to 20%, from 1% to 15%, from 2% to 15%, from 3% to 15%, from 5% to 15%, from 7.5% to 15%, and any and all ranges and subranges therebetween in the anode protective layer

In some embodiments, the particles of element M2 have a weight percentage in a range from 1% to 15%, from 2% to 15%, from 3% to 15%, from 4% to 15%, from 5% to 15%, from 7.5% to 15%, from 1% to 12.5%, from 2% to 12.5%, from 3% to 12.5%, from 5% to 12.5%, from 7.5% to 12.5%, from 1% to 10%, from 2% to 10%, from 3% to 10%, from 5% to 10%, from 7.5% to 10%, and any and all ranges and subranges therebetween in the anode protective layer.

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### EXAMPLES

### Synthesis of Solid Electrolyte Materials

In a glove box having an inert Ar atmosphere, raw precursor powders were prepared at a stoichiometric ratio. The precursor examples include, but are not limited to, Li₂S, P₂S₅, LiCl, Li₃N or combinations thereof. These powders were ball milled in a planetary ball miller at 100˜500 rpm for 1˜6 hours followed by a sintering at a temperature of 300˜600° C. for a duration in a range from 2˜24 hours.

Thereby, solid electrolyte materials with argyrodite-type structure were obtained. After a grinding procedure and a wet ball milling at 100˜500 rpm for 5˜30 hours in xylene, solid electrolyte particles have an average particle size in a range from 1 to 10 μm and will be used for preparation of SE layer.

Powder X-ray diffraction (XRD) measurement was performed using an X-ray diffractometer (SmartLab, Rigaku) with Cu-Kα radiation. Diffraction data were collected in steps of 0.01° over a 2θ range of 10-80° at a scan rate of 5° min⁻¹. XRD measurements were performed using an airtight container to prevent air exposure to the electrolyte powder. The XRD patterns of 2a, 2c, 3a and 3c are shown in FIG. 4.

### Preparation of SE Layer and Preparation of Torque Cells

For the assembly of the symmetric torque cell, 0.25 g of the sulfide electrolyte powders were first uniaxially pressed and pelletized at 5 tons in a torque cell with a diameter of 1.27 cm. Then, 2 pieces of metallic Li foils each with a thickness around 50 μm were attached to the two faces of the pelletized solid electrolyte at 10 in-lb to make a symmetric torque cell. After the cell assembly, the symmetric torque cells were placed in an oven at 75° C. for 2 hours. When the cell reached an equilibrium temperature of 75° C., the metallic Li was plated/stripped from the electrodes using step chronopotentiometry, at increasingly higher current densities from 0.1027 to 3.081 mA/cm² with a 0.1027 mA/cm² increment. At each current density, the symmetric torque cell was subjected to a step of positive current for 1 hour, followed by a step of negative current for 1 hour; these steps were then repeated once. By examining the overpotential at each step, the CCD was then determined by the step (or the current density) at which the overpotential drop compared to the previous step.

TABLE 1
CCD and Ionic conductivity (IC) for sulfide electrolytes

| | | n | x | | CCD | IC |
|---|---|---|---|---|---|---|
| Example # | Composition | (Halogen) | (N) | S/N | (mA/cm²) | (mS/cm) |
| 1a | Li₆PS₅Cl | 1 | 0 | n/a | 1.23 | 1.78 |
| 1b | Li_{6.01}PS_{4.99}N_{0.01}Cl | 1 | 0.01 | 499 | 1.13 | 1.69 |
| 1c | Li_{6.025}PS_{4.975}N_{0.025}Cl | 1 | 0.025 | 199 | 1.23 | 1.70 |
| 1d | Li_{6.1}PS_{4.9}N_{0.1}Cl | 1 | 0.1 | 49 | 1.13 | 1.70 |
| 2a | Li_{5.6}PS_{4.6}Cl_{1.4} | 1.4 | 0 | n/a | 0.62 | 4.57 |
| 2b | Li_{5.61}PS_{4.59}N_{0.01}Cl_{1.4} | 1.4 | 0.01 | 459 | 1.64 | 2.91 |
| 2c | Li_{5.625}PS_{4.575}N_{0.025}Cl_{1.4} | 1.4 | 0.025 | 183 | 1.95 | 2.75 |
| 2d | Li_{5.7}PS_{4.5}N_{0.1}Cl_{1.4} | 1.4 | 0.1 | 45 | 1.34 | 2.25 |
| 3a | Li_{5.4}PS_{4.4}Cl_{1.6} | 1.6 | 0 | n/a | 0.72 | 2.77 |
| 3b | Li_{5.41}PS_{4.39}N_{0.01}Cl_{1.6} | 1.6 | 0.01 | 439 | 0.92 | 2.59 |
| 3c | Li_{5.425}PS_{4.375}N_{0.025}Cl_{1.6} | 1.6 | 0.025 | 175 | 1.64 | 2.36 |
| 3d | Li_{5.5}PS_{4.3}N_{0.1}Cl_{1.6} | 1.6 | 0.1 | 43 | 1.44 | 1.37 |

Two-point AC electrochemical impedance spectroscopy (EIS) was used to determine the ionic conductivity. First, the sulfide electrolyte powders or sheet/film uniaxially pressed at 7 tons in a torque cell with a diameter of 1.27 cm for 3-5 minutes. Then, the pressing force was reduced slowly to 2 tons and then held at 2 tons for EIS measurements. The EIS measurements were done in a glove box at 20° C. using a Biologic system, using a frequency range from 7 MHz to 1 kHz. Based on the EIS spectra and the dimensions of the dimension of the pressed sulfide electrolyte powders or sheet, the ionic conductivities were derived. The ionic conductivity (IC) and critical current density are summarized in Table 1.

As shown in Table 1, the SE layer of 1a exhibited a CCD and IC of 1.23 mA/cm² and 1.78 mS/cm, respectively. When the total molar amount of Cl is 1.4 (n=1.4), the SE layer of 2a exhibited a CCD and IC of 0.62 mA/cm² and 4.57 mS/cm, respectively. When the total molar amount of Cl is 1.6 (n=1.6), the SE layer of 3a exhibited a CCD and IC of 0.72 mA/cm² and 2.77 mS/cm, respectively.

When the total molar amount of Cl is fixed at 1.0 for examples 1a through 1d (n=1.0, x=0.01, 0.025, and 0.1), the SE layers exhibit an ionic conductivity of no higher than 1.80 mS/cm and some are not higher than 1.70 mS/cm at 20° C. None of the examples 1a through 1d could achieve a CCD of 1.25 mA/cm² or higher. It suggests that when the total molar amount of halogen is fixed at 1.0 and the total molar amount of Li is 6.0 or greater, nitrogen doping of sulfide electrolyte plays an ignorable role in electrochemical properties such as IC and CCD.

When the total molar amount of Cl is increased from 1.0 to 1.4 in examples 2a through 2d, i.e., n=1.4 and the total molar amount of Li is between 5.6 and 5.7, the SE layers unexpectedly exhibit a much better ionic conductivity. The SE layers of 2b, 2c and 2d exhibit an ionic conductivity of 2.91 mS/cm, 2.75 mS/cm and 2.25 mS/cm at 20° C., respectively, which are significantly higher than the examples 1b through 1d. The SE layers of 2b, 2c and 2d unexpectedly exhibit a CCD of 1.64 mA/cm², 1.95 mA/cm² and 1.34 mA/cm², respectively, which are also significantly higher than the examples 1b through 1d.

When the total molar amount of Cl is further increased to 1.6 for example 3a, 3b, 3c and 3d, n=1.6 and the total molar amount of Li is between 5.4 and 5.5, the SE layer of 3b (molar amount of N is 0.01) exhibits a CCD and IC of 0.92 mA/cm² and 2.59 mS/cm, respectively. The SE layer of 3c (molar amount of N is 0.025) exhibits a CCD and IC of 1.64 mA/cm² and 2.36 mS/cm, respectively. The SE layer of 3d (molar amount of N is 0.1) exhibits a CCD and IC of 1.44 mA/cm² and 1.37 mS/cm, respectively.

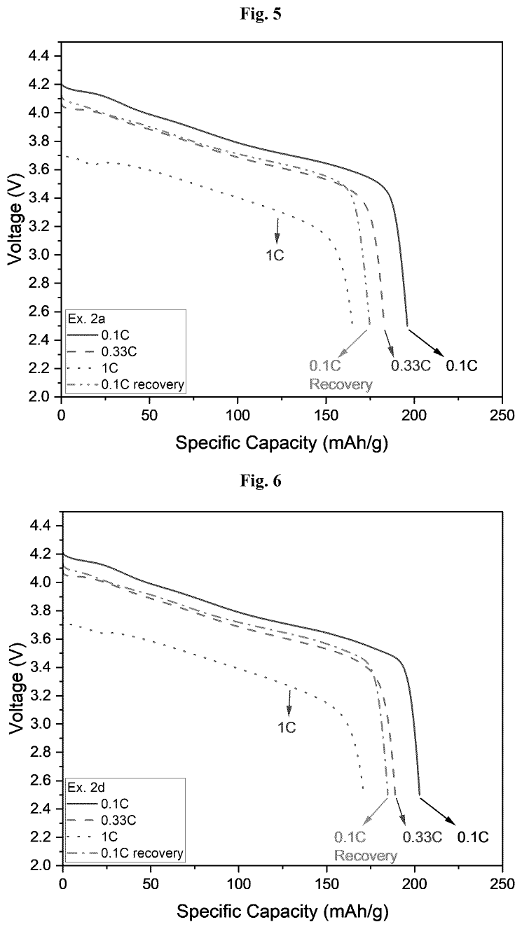

FIGS. 5 and 6 show the rate performance of pouch cells comprising an argyrodite solid electrolytes of examples 2a and 2d, respectively. The key characteristics are summarized in Tables 2 and 3.

### Preparation of SE Layer Based on Slurry Method and Assembly of Pouch Cells

Particles of the above sulfide electrolyte with a formula of Li_{5.6}PS_{4.6}Cl_{1.4} (2a) and Li_{5.7}PS_{4.5}N_{0.1}Cl_{1.4} (2d) were mixed with an acrylate binder (0.5 wt %-2.0 wt % based weight of sulfide electrolyte) and isobutyl isobutyrate as solvent, resulting a slurry. The slurry was applied to a scaffold such as non-woven fabric on a non-stick base. After the removal of the solvent, the dried coating (alternatively, sheet or film) was flexible and was peeled off from the non-stick base, thereby obtaining a solid electrolyte (SE) layer with a thickness between 60 μm and 80 μm. The SE layer was then punched into desired dimensions for ionic conductivity measurements and pouch cell assembly.

The SE was stacked between a cathode layer and an anode layer; the layers were laminated or assembled under a warm isostatic press (WIP) process to obtain an ASSB. In the ASSBs with examples 2a and 2d as SE in Tables 2 and 3 and FIGS. 5 to 8, an anode protective layer (a thickness around 5-20 μm) consisting of a carbonaceous material and a polymeric binder was used in the absence of particles of lithium alloyable element.

TABLE 2
Rate performance of pouch cells comprising
an SE layer of 2a and 2d Discharge

| | Initial Discharge Specific | | | | Recovery | |
|---|---|---|---|---|---|---|
| SE | Capacity, mAh/g | | | 1 C/0.33 C | at 0.1 C | First |
| in | @0.1 | @0.33 | @1 | capacity | discharge ^{a}, | Cycle |
| Cell | C | C | C | ratio, % | mAh/g | CE, % |
| 2a | 196.12 | 182.88 | 165.05 | 90.25 | 174.85 | 88.18 |
| 2d | 202.84 | 188.94 | 171.18 | 90.60 | 184.81 | 90.20 |

^{a} Recovery at 0.1 C discharge is determined by the fourth cycle of the rate test (or the second 0.1 C cycle).

The rate performance test of pouch cells comprising the SE of 2a and 2d was performed at a temperature of 45° C. for 4 cycles at different C-rates in the following order: 0.1C, 0.33C, 1C, 0.1C (1C=4.91 mA/cm²). The fourth cycle of the rate test (or the second 0.1C cycle) is termed 0.1C recovery. The rate performance plots are shown in FIGS. 5 and 6 and summarized in Table 2.

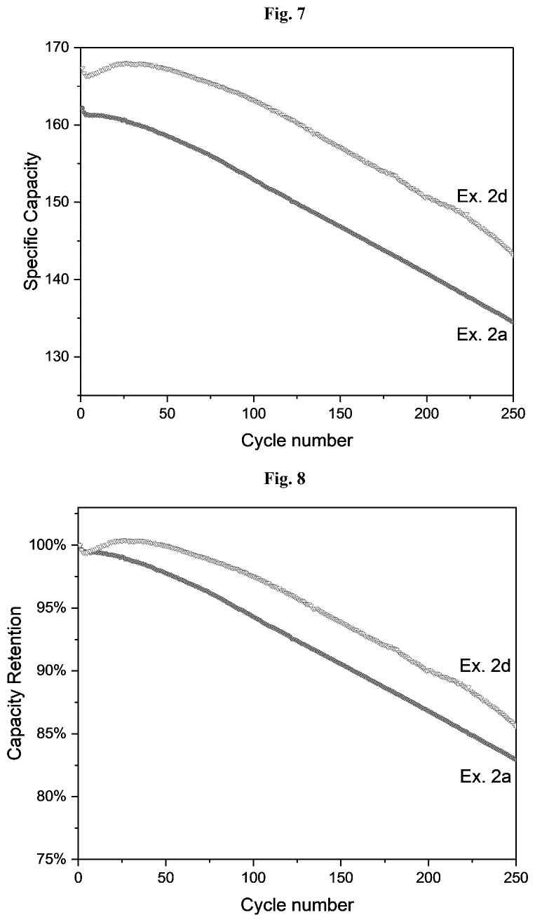

Following the rate performance test, the cycling performance test of pouch cells comprising the SE of 2a and 2d was performed at a temperature of 45° C. at 0.33C. The cycling plots are shown in FIGS. 7 and 8 and the results are summarized in Table 3. It clearly shows that the N-doped SE exhibits a higher capacity retention rate in comparison to the one with an SE not doped with nitrogen.

TABLE 3
Cycling performance of pouch cells comprising
SE of 2a and 2d at a rate of 0.33 C

| | |
|---|---|
| SE | Capacity retention rate ^{a}, % |

| in Cell | of 20^{th} cycle | of 50^{th} cycle | of 100^{th} cycle |
|---|---|---|---|
| 2a | 99.19 | 97.78 | 94.29 |
| 2d | 100.30 | 99.97 | 97.53 |

^{a} The capacity retention rate was determined by comparing the n^{th} 0.33 C cycle to the first 0.33 C cycle during the cycling test.

### Aspects

In a first aspect of the present disclosure, a solid argyrodite electrolyte has a formula (I)

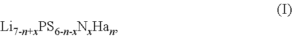

wherein Ha is a halogen element, 0.01≤x≤0.1, and 1.0<n<2.0.

In a second aspect according to the first aspect, Ha comprises at least one selected from the group consisting of fluorine (F), chlorine (Cl), bromine (Br), iodine (I), astatine (At), and tennessine (Ts).

In a third aspect according to any preceding aspect, 1.2≤n≤1.6. In some embodiments, the total molar amount of Li in Formula (I) is in a range from 5.41 to 5.90. In some embodiments, 1.2≤n≤1.4. In some embodiments, the total molar amount of Li in Formula (I) is in a range from 5.61 to 5.90.

In a fourth aspect according to any preceding aspect, 0.02≤x≤0.1.

In a fifth aspect according to any preceding aspect, the solid argyrodite electrolyte comprises at least one selected from the group consisting of Li_{5.61}PS_{4.59}N_{0.01}Cl_{1.4}, Li_{5.625}PS_{4.575}N_{0.025}Cl_{1.4}, Li_{5.7}PS_{4.5}N_{0.1}Cl_{1.4}, Li_{5.61}PS_{4.59}N_{0.01}F_{1.4}, Li_{5.625}PS_{4.575}N_{0.025}F_{1.4}, Li_{5.7}PS_{4.5}N_{0.1}F_{1.4}, Li_{5.61}PS_{4.59}N_{0.01}Br_{1.4}, Li_{5.625}PS_{4.575}N_{0.025}Br_{1.4}, Li_{5.7}PS_{4.5}N_{0.1}Br_{1.4}, Li_{5.61}PS_{4.59}N_{0.01}I_{1.4}, Li_{5.625}PS_{4.575}N_{0.025}I_{1.4}, Li_{5.7}PS_{4.5}N_{0.1}I_{1.4}, Li_{5.41}PS_{4.39}N_{0.01}Cl_{1.6}, Li_{5.425}PS_{4.375}N_{0.025}Cl_{1.6}, Li_{5.5}PS_{4.3}N_{0.1}Cl_{1.6}, Li_{5.41}PS_{4.39}N_{0.01}F_{1.6}, Li_{5.425}PS_{4.375}N_{0.025}F_{1.6}, Li_{5.5}PS_{4.3}N_{0.1}F_{1.6}, Li_{5.41}PS_{4.39}N_{0.01}Br_{1.6}, Li_{5.425}PS_{4.375}N_{0.025}Br_{1.6}, Li_{5.5}PS_{4.3}N_{0.1}Br_{1.6}, Li_{5.41}PS_{4.39}N_{0.01}I_{1.6}, Li_{5.425}PS_{4.375}N_{0.025}I_{1.6}, Li_{5.5}PS_{4.3}N_{0.1}I_{1.6}, and mixtures thereof.

In a sixth aspect according to any preceding aspect, the solid argyrodite electrolyte exhibits an ionic conductivity of at least 1.30 mS/cm at 20° C.

In a seventh aspect, an all-solid-state battery (ASSB) comprises a cathode layer; an anode layer; and a solid electrolyte layer between the cathode layer and the anode layer, wherein the solid electrolyte layer comprises the solid argyrodite electrolyte according to any preceding aspect. In some embodiments, the ASSB exhibits a critical current density (CCD) of at least 1.25 mA/cm² at 75° C.

In an eighth aspect according to the seventh aspect, the ASSB exhibits a critical current density (CCD) of at least 1.25 mA/cm² at 75° C. and the SE layer of the ASSB exhibits an ionic conductivity of at least 1.30 mS/cm at 20° C. In some embodiments, the solid electrolyte layer has a thickness in a range from 5 μm to 300 μm.

In a nineth aspect according to the seventh or eighth aspect, the cathode layer comprises a cathode current collector and a cathode active material layer on the cathode current collector, wherein the cathode active material layer comprises at least one cathode active material comprising Li, Ni, and Co and at least one of Mn and Al.
and the cathode current collector comprises at least one selected from the group consisting of Al, Ti, stainless steel, and alloy thereof.

In a tenth aspect according to the seventh aspect, the anode layer comprises an anode current collector and an anode active material layer on the anode current collector. In some embodiments, the anode active material layer comprises at least one anode active material selected from the group consisting of lithium metal and lithium alloy. In some embodiments, the anode current collector comprises at least one selected from the group consisting of Cu, stainless steel, Ti, Ni, Ta, Mo, Nb, Sn, Zn, Ag, Au, and alloy thereof.

In an eleventh aspect according to the seventh aspect, the ASSB further comprises an anode protective layer between the SE layer and the anode layer, wherein the anode protective layer comprises a carbonaceous material and a polymeric binder in the absence of lithium-alloyable elements. In some embodiments, the polymeric binder has a weight percentage in a range from 3.0 wt % to 10.0 wt % in the anode protective layer.

In a twelfth aspect according to the eleventh aspect, the anode protective layer consists of the carbonaceous material and the polymer binder. In other words, the anode protective layer does not include any lithiophilic material such as Ag.

In a thirteenth aspect according to the seventh aspect, the ASSB further comprises an anode protective layer between the SE layer and the anode layer, wherein the anode protective layer comprises a carbonaceous material, a polymeric binder and particles of an element M1 alloyable with lithium, wherein the particles of the element M1 are distributed in a matrix of the carbonaceous material. In some embodiments, element M1 comprises at least one selected from the group consisting of Ag, Zn, Ti, Cd, Mg, Al, Ga, Si, Ge, In, Sn, Pb, Bi, and Sb.

In a fourteenth aspect according to the thirteenth aspect, the anode protective layer further comprises particles of a second element M2 that is not alloyable with lithium, wherein both the particles of the element M1 and the particles of the second element M2 are distributed in a matrix of the carbonaceous material.

In a fifteenth aspect according to the fourteenth aspect, the second element M2 comprises at least one selected from the group consisting of Cu, Mo, Ir, W, Co, Ni, Ru, Fe, Se, Ta, Nb, V, and Zr.

In some embodiments, the ASSB exhibits a capacity retention rate of at least 97.5%, after at least 50 cycles at a rate of C/3 at 45° C. In some embodiments, the ASSB exhibits a capacity retention rate of at least 94.0%, after at least 100 cycles at a rate of C/3 at 45° C.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

1. A solid argyrodite electrolyte with Formula (I) 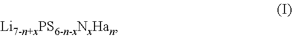
wherein Ha is a halogen element, 5.0<7−n+x<6.0, 0.01≤x≤0.1, and 1.0<n<2.0.

2. The solid argyrodite electrolyte of claim 1, wherein Ha comprises at least one selected from the group consisting of fluorine (F), chlorine (Cl), bromine (Br), iodine (I), astatine (At), and tennessine (Ts).

3. The solid argyrodite electrolyte of claim 1, wherein 1.2≤n≤1.6.

4. The solid argyrodite electrolyte of claim 1, wherein 0.02≤x≤0.1.

5. The solid argyrodite electrolyte of claim 1, wherein the solid argyrodite electrolyte comprises at least one selected from the group consisting of Li_{5.61}PS_{4.59}N_{0.01}Cl_{1.4}, Li_{5.625}PS_{4.575}N_{0.025}Cl_{1.4}, Li_{5.7}PS_{4.5}N_{0.1}Cl_{1.4}, Li_{5.61}PS_{4.59}N_{0.01}F_{1.4}, Li_{5.625}PS_{4.575}N_{0.025}F_{1.4}, Li_{5.625}PS_{4.575}N_{0.025}Br_{1.4}, Li_{5.7}PS_{4.5}N_{0.1}Br_{1.4}, Li_{5.7}PS_{4.5}N_{0.1}F_{1.4}, Li_{5.61}PS_{4.59}N_{0.01}Br_{1.4}, Li_{5.61}PS_{4.59}N_{0.01}I_{1.4}, Li_{5.625}PS_{4.575}N_{0.025}I_{1.4}, Li_{5.7}PS_{4.5}N_{0.1}I_{1.4}, Li_{5.41}PS_{4.39}N_{0.01}Cl_{1.6}, Li_{5.425}PS_{4.375}N_{0.025}Cl_{1.6}, Li_{5.5}PS_{4.3}N_{0.1}Cl_{1.6}, Li_{5.41}PS_{4.39}N_{0.01}F_{1.6}, Li_{5.425}PS_{4.375}N_{0.025}F_{1.6}, Li_{5.5}PS_{4.3}N_{0.1}F_{1.6}, Li_{5.41}PS_{4.39}N_{0.01}Br_{1.6}, Li_{5.425}PS_{4.375}N_{0.025}Br_{1.6}, Li_{5.5}PS_{4.3}N_{0.1}Br_{1.6}, Li_{5.41}PS_{4.39}N_{0.01}I_{1.6}, Li_{5.425}PS_{4.375}N_{0.025}I_{1.6}, Li_{5.5}PS_{4.3}N_{0.1}I_{1.6}, and mixtures thereof.

6. The solid argyrodite electrolyte of claim 1, wherein the solid argyrodite electrolyte exhibits an ionic conductivity of at least 1.30 mS/cm at 20° C.

7. An all-solid-state battery (ASSB) comprising:
a cathode layer;
an anode layer; and
a solid electrolyte (SE) layer between the cathode layer and the anode layer, wherein the SE layer comprises the solid argyrodite electrolyte of claim 1.

8. The ASSB of claim 7, wherein the ASSB exhibits a critical current density (CCD) of at least 1.25 mA/cm² at 75° C. and the SE layer of the ASSB exhibits an ionic conductivity of at least 1.30 mS/cm at 20° C.

9. The ASSB of claim 7, wherein the cathode layer comprises a cathode current collector and a cathode active material layer on the cathode current collector, wherein the cathode active material layer comprises at least one cathode active material comprising Li, Ni, and Co and at least one of Mn and Al, wherein the cathode current collector comprises at least one selected from the group consisting of Al, Ti, stainless steel, and alloy thereof.

10. The ASSB of claim 7, wherein the anode layer comprises an anode current collector and an anode active material layer on the anode current collector.

11. The ASSB of claim 7, further comprising an anode protective layer between the SE layer and the anode layer, wherein the anode protective layer comprises a carbonaceous material and a polymeric binder in the absence of lithium-alloyable element.

12. The ASSB of claim 11, wherein the anode protective layer consists of the carbonaceous material and the polymer binder.

13. The ASSB of claim 7, further comprising an anode protective layer between the SE layer and the anode layer, wherein the anode protective layer comprises a carbonaceous material, a polymer binder, and particles of an element M1 that is alloyable with lithium, wherein the particles of the element M1 are distributed in a matrix of the carbonaceous material.

14. The ASSB of claim 13, wherein the anode protective layer further comprises particles of a second element M2 that is not alloyable with lithium, wherein the particles of the element M1 and the particles of the second element M2 are distributed in a matrix of the carbonaceous material.

15. The ASSB of claim 14, wherein the second element M2 is at least one selected from the group consisting of Cu, Mo, Ir, W, Co, Ni, Ru, Fe, Se, Ta, Nb, V, and Zr.
